(19) United States
(12) Patent Application Publication
(10) Pub. No.: US 2019/0075743 A1
(43) Pub. Date: Mar. 14, 2019

(54) A system for improving fluid circulation in a raceway pond

(71) Applicant: RELIANCE INDUSTRIES LIMITED, Maharashtra (IN)

(72) Inventors: Ganesh Lakshman Maddikeri, Maharashtra (IN); Ganesh K. Veluswamy, Tamil Nadu (IN); Avinash Ramchandra Khopkar, Maharashtra (IN)

(21) Appl. No.: 16/085,191

(22) PCT Filed: Feb. 27, 2017
(86) PCT No.: PCT/IB2017/051117

§ 371 Date: Sep. 14, 2018

(30) Foreign Application Priority Data
Apr. 7, 2016 (IN) 201621012354

(51) Int. Cl. A01G 33/00; E02B 13/00; F15D 1/00

(52) U.S. Cl. CPC A01G 33/00; F15D 1/0025; E02B 13/00

(57) ABSTRACT

The present disclosure relates to a system for improving fluid circulation in a raceway pond. The system comprises at least one mid-wall, which is obliquely disposed within the raceway pond. The mid-wall divides the raceway pond into at least two portions, such that the portions are connected to and in fluid communication with each other. The obliquely disposed mid-wall improves the fluid circulation in the raceway pond.

### FIELD

The present disclosure relates to a system for improving fluid circulation in a raceway pond.

### BACKGROUND

A raceway pond is an artificial pond, particularly, used in the growth of microorganisms like algae. Typically, there are two types of the raceway pond, viz., open ponds and closed ponds. The raceway pond comprises a plurality of rectangular segments connected to and in fluid communication with each other. Moreover, a dividing element or a mid-wall is disposed in each rectangular segment of the raceway pond, thereby dividing each rectangular segment into two portions. Due to the mid-wall, a fluid flowing in each rectangular segment is turned by 180° therewithin. The raceway pond also comprises a pumping mechanism, such as a paddle wheel, pumps, and the like, to induce the flow movement therein, required for various purposes such as waste-water treatment, growth of microorganisms, typically bacteria and algae, and the like.

Typically, the velocity and the depth of the fluid in the raceway pond are in the range of 10 cm/s to 30 cm/s and 15 cm to 30 cm respectively. The fluid flowing in each portion of the rectangular segment is turned by 180°, at the edges or bends of the mid-wall. This leads to boundary layer separation at the edges of the mid-wall, thereby resulting in improper recirculation of the fluid and fluid velocity stratification. This, in turn, leads to the formation of dead zones in the immediate vicinity of the edges, thereby resulting in an increase in the population of unwanted microorganisms, such as grazers, that leads to frequent crashing of the raceway pond.

Conventionally, a tear-drop structure, which is either securely or removably, mounted on the edges of the mid-wall, and flow diverters are used for eliminating the formation of dead zones, and fluid velocity stratification near the edges of the mid-wall.

However, following are the drawbacks associated with the use of tear-drop structure and flow diverters:
capital expenditure (CAPEX) is increased;
available cultivation area of the raceway pond is decreased; and
problems like improper recirculation of the fluid, fluid velocity stratification, and dead zone formation near the edges of the mid-wall, are not eliminated completely.

There is, therefore, felt a need for a system to improve fluid circulation in a raceway pond, without compromising the cultivation area and the CAPEX of the raceway pond.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a system to improve fluid circulation in a raceway pond.

Other objects and advantages of the present disclosure will be more apparent from the following description, which is not intended to limit the scope of the present disclosure.

### SUMMARY

The present disclosure envisages a system for improving fluid circulation in a raceway pond. The system comprises at least one mid-wall, which is disposed within the raceway pond for dividing the raceway pond into at least two portions, such that the portions are connected to and in fluid communication with each other.

The mid-wall of the present disclosure is obliquely disposed in the raceway pond, so as to improve the fluid circulation in the raceway pond.

The mid-wall is oblique at an angle in the range of 0.5° to 1° with respect to the longitudinal axis of the raceway pond.

The mid-wall can be made up of at least one material selected from the group consisting of masonry, clay, plastic, wood, metal and fibrous material.

### BRIEF DESCRIPTION OF ACCOMPANYING DRAWINGS

A system for improving fluid circulation in a raceway pond will now be described with the help of the accompanying drawing, in which:

FIG. 1 illustrates a schematic view of a system in accordance with the present disclosure;

FIGS. 2A to 2C illustrate the formation of dead zones near the edges of a mid-wall in accordance with the present disclosure; and

FIG. 3 depicts a graph of dead zone and pressure drop versus orientation of a mid-wall in accordance with the present disclosure.

### DETAILED DESCRIPTION

As described herein above, a fluid is turned by 180° at the edges of a mid-wall disposed in each rectangular segment of a raceway pond, thereby resulting in boundary layer separation at the edges of the mid-wall. This leads to improper recirculation of the fluid, and fluid velocity stratification in each rectangular segment of the raceway pond. Due to this, dead zones are formed in the immediate vicinity of the edges, thereby resulting in an increase in the population of unwanted microorganisms, such as grazers, that leads to frequent crashing of the raceway pond.

In order to obviate crashing of the raceway pond, there is a need to eliminate the formation of dead zones, improper fluid recirculation, and fluid velocity stratification near the edges of the mid-wall. A tear-drop structure, and flow diverters are conventionally used for eliminating the above mentioned drawbacks.

However, there are certain limitations associated with the use of tear-drop structure, and flow diverters, for instance:
reduce the cultivation area of the raceway pond;
increase in the CAPEX of the raceway pond; and
inefficient elimination of the above mentioned drawbacks.

The present disclosure, therefore, provides a system for improving fluid circulation in a raceway pond, and attenuating the above mentioned limitations.

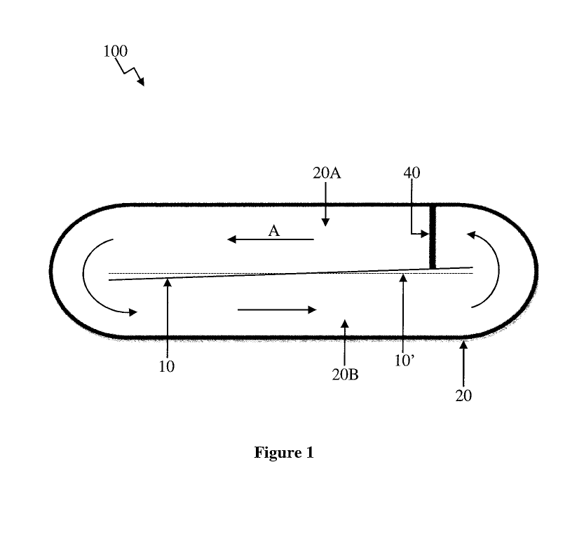

The system (100) of the present disclosure is described with reference to FIG. 1. The system (100) comprises at least one mid-wall (10) which is disposed within the raceway pond (20) for dividing the raceway pond (20) into at least two portions (20A, 20B), such that the portions (20A, 20B) are connected to and in fluid communication with each other.

The raceway pond (20) is a water-body.

The mid-wall (10) can be made up of at least one material selected from the group consisting of masonry, clay, plastic, wood, metal and fibrous material.

The system (100) also comprises a pumping mechanism (40) for creating one of clockwise circulation and anti-clockwise circulation of the fluid within the portions (20A, 20B) of the raceway pond (20).

The pumping mechanism (40) can be at least one selected from the group consisting of a paddle wheel, a linear jet, a rotating drum, a propeller, and a pump.

Conventionally, a mid-wall (10′) is disposed parallel to the longitudinal axis of the raceway pond (20). This leads to boundary layer separation of the fluid at the edges of the mid-wall, thereby resulting in improper fluid recirculation, and fluid velocity stratification near the edges of the mid-wall. Due to this, dead zones are formed at the immediate vicinity of the edges of the mid-wall (10′), which results in an increase in the population of unwanted microorganisms, such as grazers, thereby crashing the operation of the raceway pond (20).

In order to avoid the growth of unwanted microorganisms, the mid-wall (10) is obliquely disposed in the raceway pond (20). The mid-wall (10) is oblique at an angle in the range of 0.5° to 1° with respect to the longitudinal axis of the raceway pond (20). Due to the oblique orientation of the mid-wall (10), the fluid, flowing in the direction (A) in the raceway pond, is contracted and expanded along the path around the mid-wall (10). During the contraction and expansion of the fluid, boundary layer separation of the fluid at the edges of the mid-wall (10) is minimized, i.e., during 180° turn of the fluid in the raceway pond, separation of the fluid, from the surface of the edges of the mid-wall (10), is minimized. This facilitates in improving the fluid circulation, and reducing fluid velocity stratification near the edges of the mid-wall (10). Due to this, the formation of dead zones in the immediate vicinity of the edges of the mid-wall (10) is attenuated.

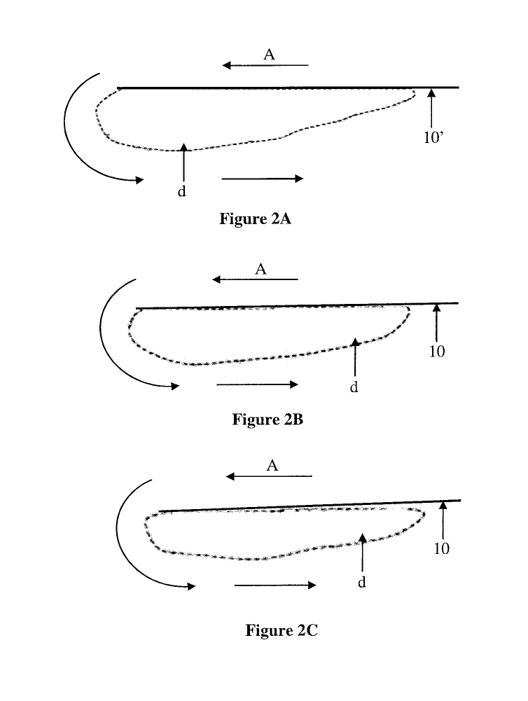

In case of the mid-wall (10′), which is disposed parallel to the longitudinal axis of the raceway pond (20) or at 0° (without re-orientation of the mid-wall (10′)), the formation of dead zone (d) is significantly greater than the dead zone (d) formed after disposing the mid-wall (10) at an angle of 0.5° and 1° (as illustrated in FIGS. 2A to 2C).

The formation of dead zone (d) in case of the mid-wall (10′) can be 4.23% of the total pond area.

In accordance with one embodiment of the present disclosure, the formation of dead zone (d) in case of the mid-wall (10) disposed at an angle of 0.5° can be 2.75% of the total pond area.

In accordance with another embodiment of the present disclosure, the formation of dead zone (d) in case of the mid-wall (10) disposed at an angle of 1° can be 2.78% of the total pond area.

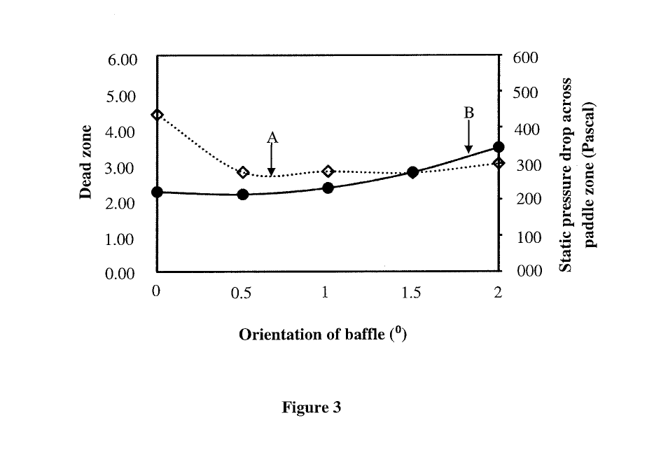

Static pressure drop of the fluid near the edges of the mid-wall (10) is increased during the contraction and expansion of the fluid near the edges of the mid-wall (10). Since, the mid-wall (10) is obliquely disposed in the raceway pond (20), at an angle in the range of 0.5° to 1°, dead zone around the edges of the mid-wall (10) is reduced (as represented by curve A of FIG. 3), and the static pressure drop across the paddle zone is increased (as represented by curve B of FIG. 3).

The system (100) is capable of reducing the formation of dead zones in the immediate vicinity of the edges of the mid-wall (10), due to which the fluid circulation in the raceway pond (20) is improved. Moreover, due to a reduction in the formation of dead zones, the growth of unwanted microorganisms, such as grazers, is reduced.

### Technical Advances and Economical Significance

The present disclosure described herein above has several technical advantages including, but not limited to, the realization of a system that:
improves the fluid circulation in the raceway pond;
reduces the formation of dead zones in the immediate vicinity of the edges of the mid-wall, thereby reducing the growth of unwanted microorganisms, such as grazers; and
obviates crashing of the operation of the raceway pond, particularly algal culture.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for improving fluid circulation in a raceway pond, said system comprising:
at least one mid-wall disposed within said raceway pond for dividing said raceway pond into at least two portions such that said portions are connected to and in fluid communication with each other,
characterized in that, said at least one mid-wall is obliquely disposed in said raceway pond, thereby improving the fluid circulation in said raceway pond.

2. The system as claimed in claim 1, wherein said at least one mid-wall is oblique at an angle in the range of 0.5° to 1° with respect to the longitudinal axis of said raceway pond.

3. The system as claimed in claim 1, wherein said at least one mid-wall is disposed in said raceway pond.

4. The system as claimed in claim 1, wherein said mid-wall is made up of at least one material selected from the group consisting of masonry, clay, plastic, wood, metal and fibrous material.

5. The system as claimed in claim 1, wherein a pumping mechanism is provided in said raceway pond, said pumping mechanism is adapted for creating one of clockwise circulation and anti-clockwise circulation of said fluid within said portions of said raceway pond.

6. The system as claimed in claim 5, wherein said pumping mechanism is at least one selected from the group consisting of a paddle wheel, a linear jet, a rotating drum, a propeller, and a pump.

7. The system as claimed in claim 1, wherein said raceway pond is a water-body.
